(19) United States
(12) Patent Application Publication
(10) Pub. No.: US 2018/0329209 A1
(43) Pub. Date: Nov. 15, 2018

(54) METHODS AND SYSTEMS OF SMART EYEGLASSES

(71) Applicant: ROHILDEV NATTUKALLINGAL, MALAPPURAM (IN)

(72) Inventor: ROHILDEV NATTUKALLINGAL, MALAPPURAM (IN)

(21) Appl. No.: 15/822,082

(22) Filed: Nov. 24, 2017

(30) Foreign Application Priority Data
Nov. 24, 2016 (IN) IN201641040253
Dec. 4, 2016 (IN) IN201641041189

(51) Int. Cl. G02B 27/01; G06F 3/01; G06T 19/00

(52) U.S. Cl. CPC G02B 27/017; G06T 19/006; G06F 3/017

(57) ABSTRACT

In one aspect, a method of a smart eyeglass system includes the step of providing a smart eyeglass system. The smart eyeglass system includes a digital video camera system. The digital video camera system is coupled with a processor in the smart eyeglass system, and wherein the smart eyeglass system is worn by a user. With the video camera integrated into the smart eyeglass system the method obtains an image of a pair of a set of user fingers in a space in front of the user as a function of time. A user's palm of each hand is facing the video camera system. With the processor, the method identifies each finger of a set of user fingers on each hand of the user. The method identifies a set of finger pad regions of each finger of the set of user fingers. The method identifies a thumb of each hand.

This application claims priority to Indian Patent Application No. IN201641040253, filed on 24 Nov. 2016, and titled INTELLIGENT MOBILE COMMUNICATION DEVICE. This application claims priority to Indian Patent Application No. IN201641041189 filed on 4 Dec. 2016, and titled METHOD AND SYSTEM FOR MIXED REALITY DISPLAY USING MOBILE COMPUTING DEVICE AND WEARABLE OPTICAL SEE THROUGH GLASS. These applications are incorporated by reference in their entirety.

### BACKGROUND

### 1. Field

This application relates to a system, article of manufacture and method for SMART EYEGLASSES.

### 2. RELATED ART

Various varieties of smart wearable eyeglasses are currently in the market. Mobile computing devices have limited size display and user can only view content in the small limited view. For example, if the mobile computing device display size is five inches then user can only view content in the five-inch display size. Additionally, current head mounted displays including smart eyeglasses, augmented reality displays, mixed reality displays etc. can be bulky and not comfortable for a user to wear for extended. Additionally, various smart wearable eyeglasses may need additional processing power and position tracking power to improve the user experience.

### BRIEF SUMMARY OF THE INVENTION

In one aspect, a method of a smart eyeglass system includes the step of providing a smart eyeglass system. The smart eyeglass system includes a digital video camera system. The digital video camera system is coupled with a processor in the smart eyeglass system, and wherein the smart eyeglass system is worn by a user. With the video camera integrated into the smart eyeglass system the method obtains an image of a pair of a set of user fingers in a space in front of the user as a function of time. A user's palm of each hand is facing the video camera system. With the processor, the method identifies each finger of a set of user fingers on each hand of the user. The method identifies a set of finger pad regions of each finger of the set of user fingers. The method identifies a thumb of each hand. The method tracks the thumb. The method assigns each finger pad of the set of finger pad regions to a specified functionality of the smart eyeglass system. The method detects a series of thumb tapping movements to one or more finger pad regions of each finger of the set of user fingers. A tapping of a finger pad region is determined by the steps of identifying a set of other fingers and other finger pad regions that are not overlapped by the thumb and identifying which of the set of other fingers and the other finger pad regions that are left of the thumb, right of the thumb, above the thumb and below the thumb.

### BRIEF DESCRIPTION OF THE DRAWINGS

FIG. 1 illustrates an example of smart eyeglasses or head-mounted display that can connect with mobile computing device through wireless communication system or wired connections, according to some embodiments.

FIG. 2 illustrates a system that includes smart eyeglasses or head-mounted display, mobile computing device and cloud, according to some embodiments.

FIG. 3 illustrates an example of smart eyeglasses have different components, according to some embodiments.

FIG. 4 illustrates an example of smart eyeglasses that can use data from sensors in the mobile computing device, according to some embodiments.

FIG. 5 illustrates an example instant application implemented in smart eyeglasses, according to some embodiments.

FIG. 6 illustrates smart eyeglasses that uses input systems, according to some embodiments.

FIG. 7 illustrates an example of smart eyeglasses that have displayed an application menu, according to some embodiments.

FIG. 8 illustrates an example wherein a user can navigate a cursor through smart eyeglasses, according to some embodiments.

FIG. 9 illustrates an example system wherein a user can manage multiple instant application windows using smart eyeglasses and gesture input, according to some embodiments.

FIG. 10 an example use case with user playing games, according to some embodiments.

FIG. 11 illustrates an example of a user watching videos and/or images in a bigger screen size using smart eyeglasses, according to some embodiments.

FIG. 12 illustrates an example of augmented reality shopping and suggestions, according to some embodiments.

FIG. 13 illustrates an example of a user receiving calls, application notifications, reminders, alarms, social media updates etc. with the smart eyeglasses via a local mobile computing device, according to some embodiments.

FIG. 14 illustrates an example of a user moving files between air windows using cursor and hand gestures, according to some embodiments.

FIG. 15 illustrates an example of a user providing input to smart eyeglasses using mobile computing device touch interfaces, according to some embodiments.

FIG. 16 illustrates a user using hand to provide input(s) to the smart eyeglasses, according to some embodiments.

FIG. 17 illustrates an example wake up and sleep process of smart eyeglasses, according to some embodiments.

FIG. 18 illustrates a process of placing a user's hand in the field of view of a video camera, according to some embodiments.

FIGS. 19 A-D illustrate a process of a user hand placed in the field of view of a video camera embedded in the smart eyeglasses, according to some embodiments.

FIG. 20 illustrates a user adding their interest in buying items in the smart glasses, according to some embodiments.

FIG. 21 illustrates a system used to identify user finger segments for dialing numbers or type alphabets, according to some embodiments.

FIG. 22 illustrate a figure digital dial pad displayed on user finger segments, according to some embodiments.

FIG. 23 illustrates an example alphabetic keyboard on two hands, according to some embodiments.

FIG. 24 illustrates an example process for implementing a smart eyeglass system, according to some embodiments.

FIG. 25 depicts an exemplary computing system that can be configured to perform any one of the processes provided herein.

FIG. 26 is a block diagram of a sample computing environment that can be utilized to implement various embodiments.

FIG. 27 an example depth camera process, according to some embodiments.

The Figures described above are a representative set, and are not an exhaustive with respect to embodying the invention.

### DESCRIPTION

Disclosed are a system, method, and article of smart eyeglasses. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures,or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors ray be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Definitions

Example definitions for some embodiments are now provided.

Application programming interface (API) can specify how software components of various systems interact with each other.

Augmented reality (AR) is a live direct or indirect view of a physical, real-world environment whose elements are augmented by computer-generated sensory input such as sound, video, graphics or GPS data.

Bar code is an optical, machine-readable, representation of data; the data usually describes something about the object that carries the barcode.

Cloud computing can involve deploying groups of remote servers and/or software networks that allow centralized data storage and online access to computer services or resources. These groups of remote serves and/or software networks can be a collection of remote computing services.

QR code (Quick Response Code) can be a type of matrix barcode (and/or two-dimensional barcode).

Real Time Streaming Protocol (RTSP) is a network control protocol designed for use in entertainment and communications systems to control streaming media servers. The protocol is used for establishing and controlling media sessions between end points. Clients of media servers issue VCR-style commands such as play, record and pause, to facilitate real-time control of the media streaming from the server to a client (Video On Demand) or from a client to the server (Voice Recording).

Real-time Transport Protocol (RTP) is a network protocol for delivering audio and video over IP networks. RTP is used extensively in communication and entertainment systems that involve streaming media, such as telephony, video teleconference applications, television services and web-based push-to-talk features.

Time-of-flight camera (TOF camera) is a range imaging camera system that resolves distance based on the known speed of light, measuring the time-of-flight of a light signal between the camera and the subject for each point of the image.

Example Systems and Methods

Some embodiments can be used create an augmented reality and larger screen experience with smart eyeglasses or head-mounted display device, optical smart eyeglasses or head-mounted display device, spectacles or eyeglasses as a daily wear, small form factor and low battery consumption for comfortable wearing all-day-use for users. Smart eyeglasses can use mobile computing devices or cloud-computing platform for computation, storage and other sensors data inputs including but not limited to position and location but not limited to GPS, accelerometer, gyroscope, magnetometer, cellular modems including not limited to LTE, 3G etc., Wi-Fi, light sensors, depth camera, 2D camera, biometric sensors, health sensors, USB (Universal Serial Bus), etc. The operating system or application in the smart glasses or mobile computing device, can intelligently identify or manage which application, process, memory etc., need to manage or process from smart eyeglasses and which application, process, memory etc., need to manage or process from mobile computing devices or cloud. Each user's most using or wanted applications, features and store that application or features related data in the smart glasses, rest applications and features related data can store in the mobile computing device including but not limited to smartphones, tablets, palmtops, laptops desktops, etc., or cloud, when used by smart eyeglasses can immediately access those data and information from mobile computing device or cloud-computing platform through IEEE 802.11 (e.g. including but not limited to other IEEE 802.11, LTE and/or other cellular technologies or BLUETOOTH™ Radio Technologies or wired transfer).

Smart glasses operating m also allows users to run instant applications. Instant application is a method to open applications instantly without installing it in smart eyeglasses or head-mounted display device. Smart eyeglasses or head-mounted display device operating system or applications can identify user's most used applications or recent applications and features according to that the application data and information can be saved in smart eyeglasses for instant application access. Some data or information including but not limited to Log-in details, passwords, user names, payment details, user contacts, profile images, etc. related to instant applications can store permanently in smart eyeglasses or head-mounted display device. Instant applications can use Internet from mobile computing device. Instant applications can also run from a cloud-computing platform.

In one example, if user select an application from the application menu in smart eyeglasses or from the mobile computing device application menu. The opened application can be instantly viewed in smart eyeglasses display in front of user's field of view in the real-world environment. For example, if the user opened a recipe instant application from the menu then application can open up in the smart eyeglasses and user can see the computer-generated data and visuals in the real-world environment of user's field of view. The application window can be scalable, move around different directions using input methods including but not limited to finger gestures, touch interface on the mobile computing device, gestures, input methods described in the other related patents invented by the same inventor of this patent. When the user opens the application for the first time from smart eyeglasses then the operating system can save data related to the application in the mobile computing device memory or cloud-computing platform and temporarily in smart eyeglasses memory. Some data or all data can be saved permanently in the smart glasses' memory also. When user open the same application in the near future and if the application related data is existing in the smart eyeglasses memory or optical smart eyeglasses memory then it can load data from smart eyeglasses otherwise it can load the data from mobile computing device memory or cloud.

Using this method, the eyeglasses cannot do any high level complex processing but the mobile computing device including but not limited to smartphones, tablets, wearable devices, personal computers, laptops, smart home devices, automobiles, personal digital assistant, holographic computers, etc., can do all the major processing and transfer the outputs data to eyeglasses.

The system contains smart eyeglasses integrated with near eye displays including but not limited to waveguide optics display, light field display, retinal projection display, light source, processor, memory, IEEE 802.11, bone conduction speaker, microphone, depth sensing camera or 3D camera or 2D camera, batteries, wireless charger, accelerometer, gyroscope, compass, touch sensor, fingerprint sensor, LED etc. and mobile computing device can wirelessly connect using wireless communication technologies with the smart eyeglasses. The operating system installed in smart eyeglasses can use Internet through mobile computing device. The applications installed in smart eyeglasses can use Internet and display information to the users. The Internet can share from mobile computing device to smart eyeglasses through Wi-Fi.

Smart eyeglasses can take inputs from 3D video camera/depth camera, 2D camera, or 3D camera, accelerometer, gyroscope, compass, touch sensor, microphone embedded in smart eyeglasses and also take inputs from mobile computing device capacitive touch surface. These inputs can be used to interact with the instant applications on smart eyeglasses or head-mounted display device.

Smart eyeglasses provide outputs through near eye displays including but not limited to waveguide optics display, light field display, retinal projection display etc., LED and bone conduction speaker.

The application installed in the mobile computing device can also get data from other sensors including but not limited to Fingerprint sensors, touch sensors, camera, microphone, speaker, light sensors, position and location sensors not limited to GPS, accelerometer, gyroscope, magnetometer etc., LTE, Wi-Fi, BLUETOOTH™, 3D sensors, TOF sensors, USB, etc. embedded in the mobile computing device and send those data into smart eyeglasses or head-mounted display device.

The application software installed in the mobile computing device can get or send data in the format of including but not limited to images, strings, audio, video, gestures, messages, notifications, text, 3D data, 3D images or videos etc. to smart eyeglasses and vice versa.

Application Software installed in the mobile computing device can generate smart eyeglasses operating system requested outputs in the form of a digital format including but not limited to images, strings, audio, video, gestures, messages, notifications, text, 3D data, 3D images or 3D videos etc. and transfer that data into smart eyeglasses through wireless technologies. The wireless technology can be embedded in smart eyeglasses can receive that data from mobile computing device or cloud-computing platform and send to the processor in the smart eyeglasses unit. The processor can then send the data to outputs sensors including but not limited to near eye displays including but not limited to waveguide optics display, light field display, retinal projection display, etc., LED and bone conduction speaker. This method uses low power consumption and low processing on the eyeglasses and provide high quality outputs. The mobile computing device can also be used to provide input from the touch sensor available in the mobile computing device, fingerprint sensors, microphones, GPS, Position Sensors, etc. User can use keyboards and other gestures from the mobile computing device's touch pad/sensor.

Instant application image gallery example is now discussed. The image gallery instant application can run in the smart eyeglasses can access user's images from mobile computing device or cloud-computing platform through Wi-Fi and display through the image gallery instant application in the smart eyeglasses or head-mounted display device. The application installed in the mobile computing device or cloud-computing platform can access mobile computing device memory and access the images. After that the application installed in the mobile computing device can compress the data and send to smart eyeglasses through wireless technologies. In this way the smart eyeglasses may not permanently store all the images in the smart eyeglasses memory. If user moves thumb from one direction to another over the other fingers the user can navigate through their image gallery in the smart eyeglasses or head-mounted display device. To do that 3D camera or 2D camera embedded in smart eyeglasses can capture user hand images and identify the movements and gestures. According; to the gestures the images can change in the instant image gallery'application. User can also use their mobile computing device touch screen, or other inputs devices to control computer-generated contents in the smart eyeglasses or head-mounted display device. Now the user can be able to see the images from the image gallery in a much larger size as well as blended in the user's field of view in the real-world environment.

A microphone can be attached in the eyeglasses and can capture a user's voice and transfer the audio to the application installed in the mobile computing device. Application installed in the mobile computing device can stream Audio to smart eyeglasses through IEEE 802.11 (e.g. including but not limited to other IEEE 802.11 revisions, LTE or other cellular technologies or'BLUETOOTH™ Radio Technologies, etc.) and transfer the data to bone conduction speaker embedded in the eyeglasses. The Augmented AI Avatar can be seen to the user superimposed in the real world giving a personal assistant experience virtually. One example embodiment can switch to personal mode and business mode. With a physical button or a software interface. Business people can even set a timer to switch between personal mode and business mode.

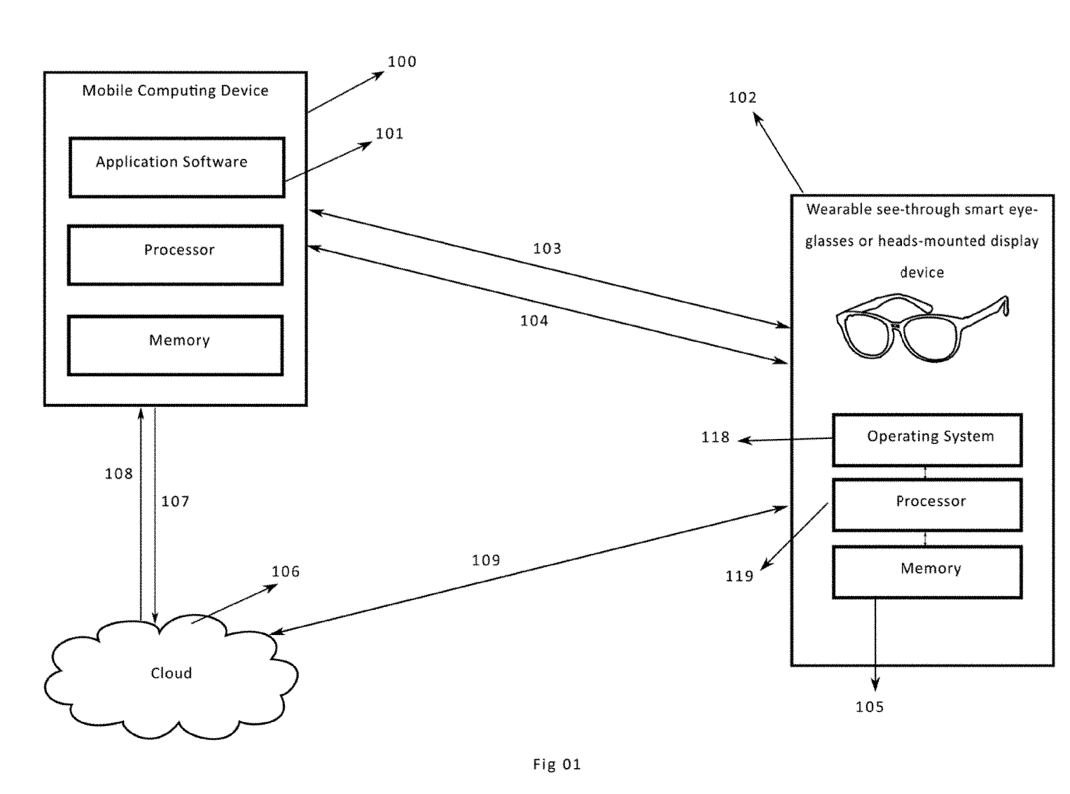

FIG. 1 illustrates an example of smart eyeglasses 102 that can connect with mobile computing device 100 through wireless communication system 103 or wired connections 104, according to some embodiments. Smart eyeglasses (e.g. can be a head-mounted display, other smart glasses, etc.) 102 can connect with cloud-computing platform 106 through wireless communication system 109. Cloud-computing platform 106 connections can be done with wireless communication 108 and 107 through mobile computing device 100. Mobile computing device 100 is connected through wireless communication system 103, 109 or wired connections 104 with cloud-computing platform 106 or mobile computing device 100 for computing requirement and storage. The instant applications running in the smart eyeglasses 102 may use mobile computing device 100 or cloud-computing platform 106 for Internet access, storage, processing large tasks or algorithms and display outputs in the smart eyeglasses device 102.

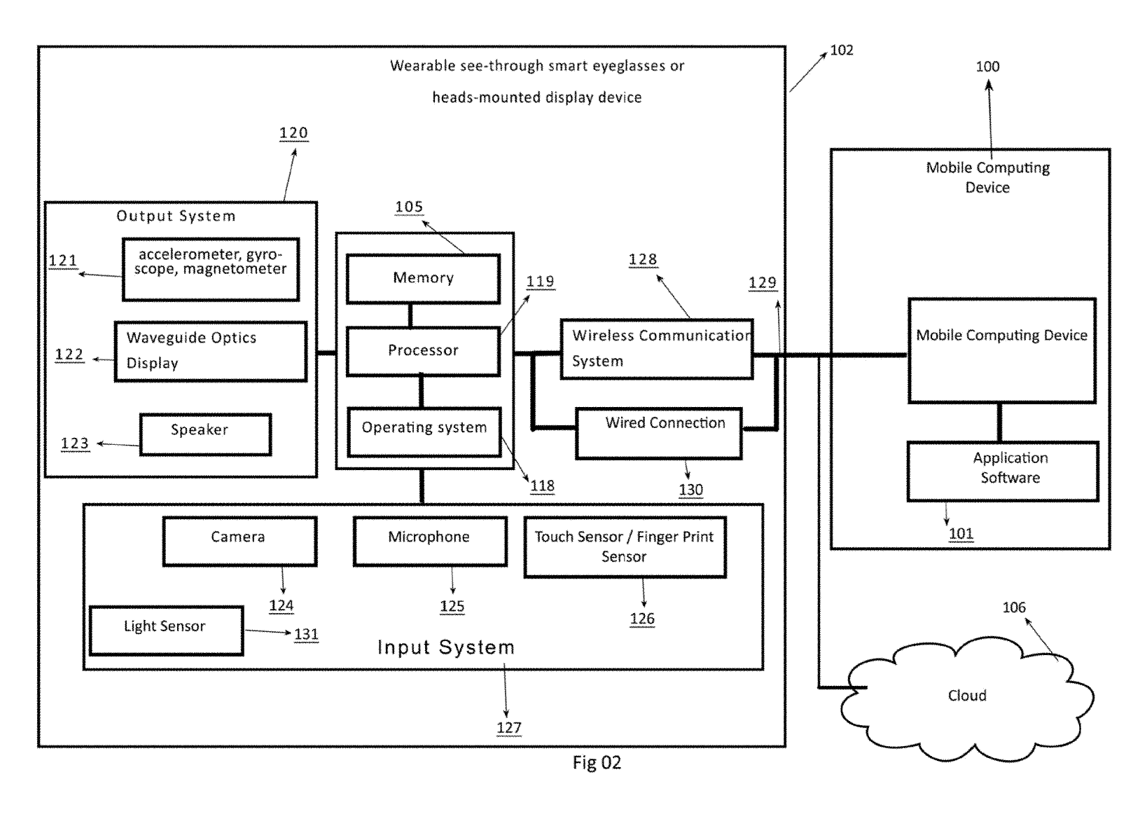

FIG. 2 illustrates a system that includes smart eyeglasses 102, mobile computing device 100 and cloud-computing platform 106, according to some embodiments. smart eyeglasses device 102 contains outputs system 120, input system 127, processor 119, wireless communication system 128. The outputs system 120 contains near eye displays including but not limited to waveguide optics display, light field display, retinal projection display, etc. 122, bone conduction speaker 123 and accelerometer, gyroscope, magnetometer 121. Input system 127 contains 3D/depth camera or 2d camera 124, microphone 125, touch sensor or fingerprint sensor 126, ambient light sensors 131. Application software 101 installed in the mobile computing device 100 can send or receive data from smart eyeglasses device 102 or cloud-computing application 106 through wireless communication system 128 or wired connections 130. Input system 127 can send the real-time data from the sensors 124, 125, 126 to mobile computing device 100 or cloud-computing platform 106 through wireless communication system 123 or wired connections 130. The processor 119 and operating system 118 in the smart eyeglasses device 102 can gather the data from input systems 127 and can process it to identify the specific input Some data from input device 127 can transfer to mobile computing device 100 or cloud-computing platform 106 through wireless communication system 128 or wired connections 130 for processing and storage. The application software 101 generated or mobile computing device 100 generated or cloud-computing platform 106 generated outputs can be transferred to smart eyeglasses device 102 through wireless communication system 128 or wired connections 130. The operating system 118 in the smart eyeglasses 102 or applications installed in the smart eyeglasses 102 can receive the data from mobile computing device 100 or cloud-computing platform 106 and display the outputs through outputs system 120 in the smart eyeglasses 102. Microphone 125 can send the audio inputs to the processor 119 and then into the mobile computing device 100 or cloud-computing platform 106 through wireless communication system 128. The mobile computing device 100 or cloud-computing platform 106 can do the audio processing or speech recognition or natural language processing, that can be used to recognize users voice commands or talk over a phone call. The processed outputs can be transferred to smart eyeglasses 102 for giving proper outputs to the user.

Touch sensor or fingerprint sensor 126 can identify users touch gestures to navigate on menu or selecting items, or various other functions and features in smart eyeglasses 102. Fingerprint sensor 126 can help to identify the user and provide security for the smart eyeglasses 102.

Bone conduction speakers 123 can help to provide audio outputs to the user. The smart eyeglasses 102 can get audio data from mobile computing device 100 or cloud-computing platform 106 or smart eyeglasses 102 itself generated audio and can provide audio feedback to the user through bone conduction speaker 123.

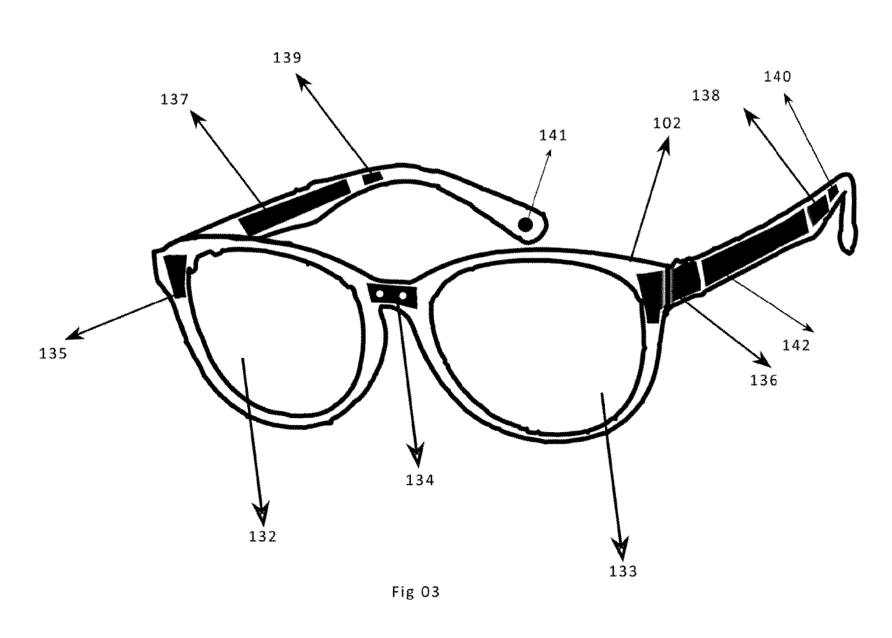

FIG. 3 illustrates an example of smart eyeglasses 102 have different components, according to some embodiments. Various components can include, inter alia: Optical light engines 135, 136, waveguide optics, or light field optics or retinal projection display optics 132, 133, 3d/depth camera and/or RGB camera 134, batteries 137, 138, charging 141, bone conduction speakers 139, 140, processing unit, memory, wireless communication unit, microphone, position sensors, light sensors, touch and fingerprint sensor 142. The alignments of components are proposed but different positions and sizes can also be explored and accommodated.

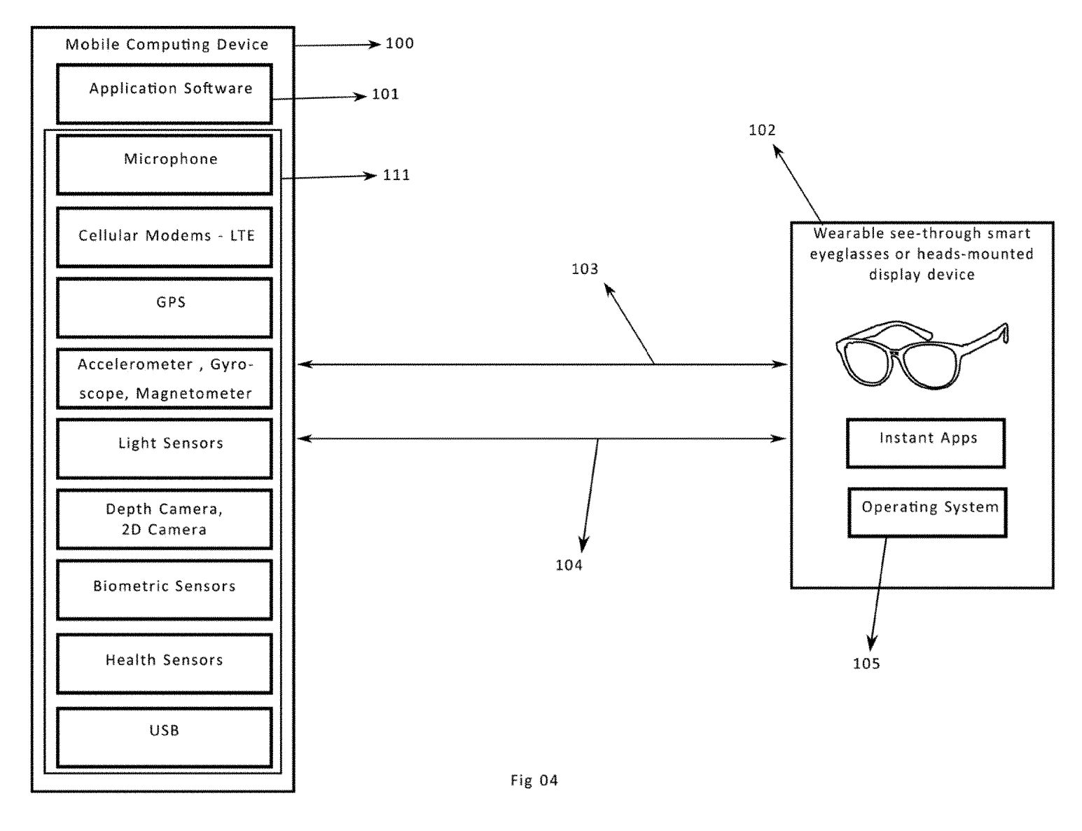

FIG. 4 illustrates an example of smart eyeglasses 102 may use data from sensors 111 in the mobile computing device 100, according to some embodiments. The data can be transferred through wireless communication system 103 or wired connections 104 between smart eyeglasses 102 and mobile computing device 100. Operating system 105 and instant applications in the 102 can use the sensor information or data to provide better outputs to the user.

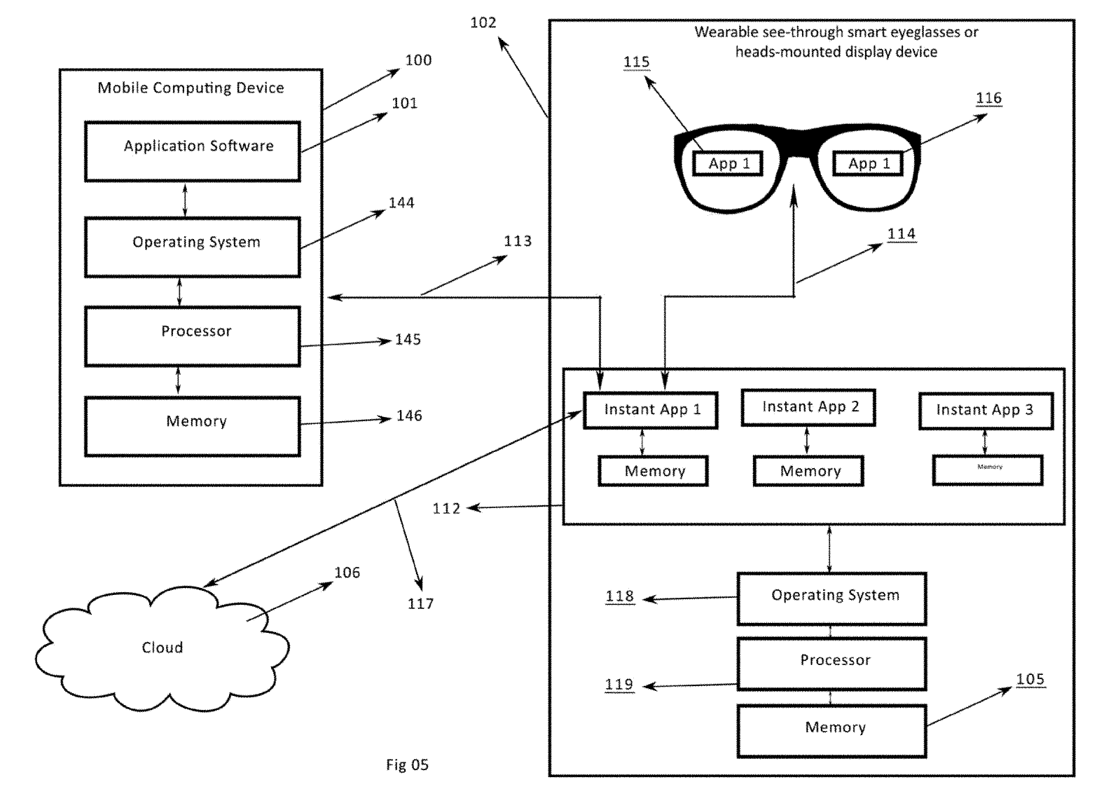

FIG. 5 illustrates an example instant application 112 in the smart eyeglasses 102, according to some embodiments. Instant applications 112 installed in the smart eyeglasses 102 may have cache memory or storage in cloud-computing platform 106 or mobile computing device 100 for quick access of necessary data for the instant application 112. When user select an instant application 112 from the smart eyeglasses 102 application menu, then the operating system 118 in the smart eyeglasses 102 can identify multiple conditions including but not limited to “1. If the application is recently opened/used or not”, “2. If the instant application 112 is most used application or not, or the instant application 112 is a favorite application of user or not”, “3. Is the instant application 112 need more computing power or memory”, “4. Is the application 112 need computing, memory or storage support from mobile computing device or cloud”. If the scenario is 1 or 2 then the instant application 112 related data may be already stored in the smart eyeglasses 102 memory 105 and instant applications 112 can run using smart eyeglasses 102 processor 119 and memory 105, without completely depending on mobile computing device 100 or cloud-computing platform 106. But the instant application 112 may use Internet from mobile computing device 100 to send or receive data, computing/processor 119 or memory 105 may use from smart eyeglasses 102 itself, or some data may be accessed from mobile computing device 100 memory 146 or use mobile computing device 100 processor 145 or cloud. If the scenario is 3 or 4 then the instant application 112 or operating system 118 in the smart eyeglasses 102 may use mobile computing device 100 memory 146, processor 145 or cloud-computing platform 106 for computation or memory or storage. Application software 101 installed in the mobile computing device 100 or cloud-computing platform 106 may provide necessary outputs for the smart eyeglasses 102. All the communication between mobile computing device 100, cloud-computing platform 106 and smart eyeglasses 102 can happen though wireless communication system 113, 117 or wired connections.

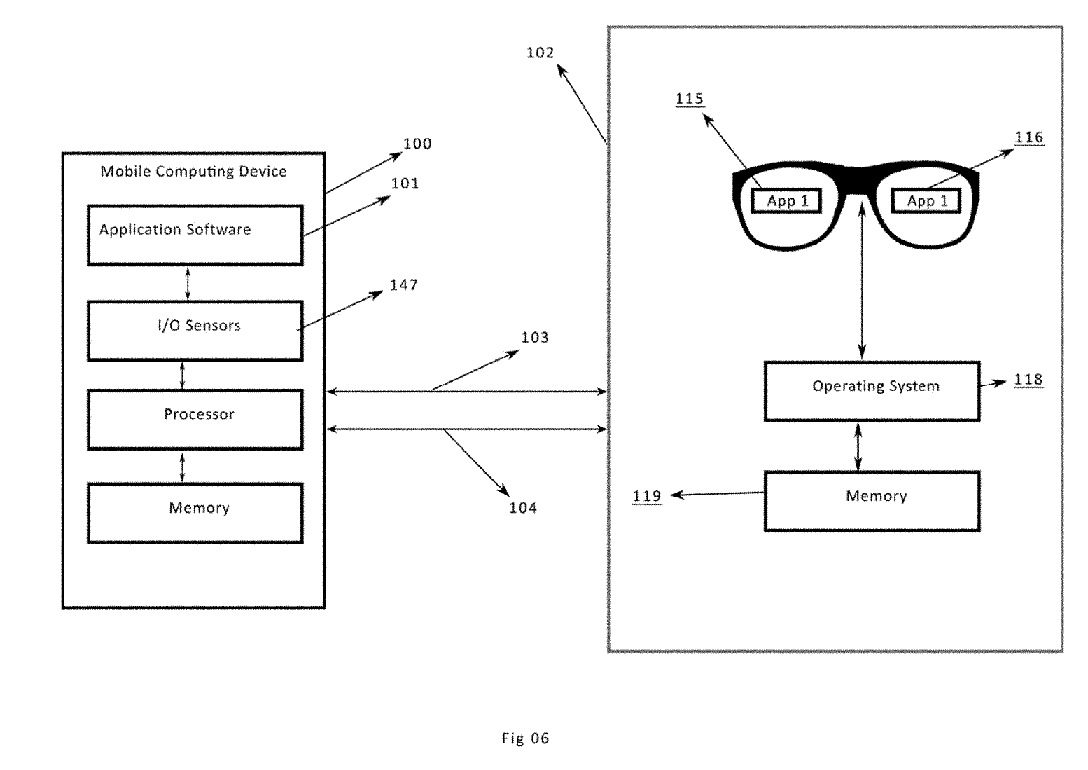

FIG. 6 illustrates smart eyeglasses 102 that use input systems, according to some embodiments. Input systems can include, inter alia: touchscreen inputs, microphone, camera, light sensors, biometric sensors, GPS, Positioning sensors, location sensors, health sensors, smart home devices, automobile devices, etc. in the mobile computing device 100 for methods including but not limited to interacting with displayed computer-generated outputs, biometric security, location and position tracking, environment tracking, health data, smart home data, automobile data, etc. in the smart eyeglasses 102. Application software installed 101 in the mobile computing device may connect other I/O sensors 147 data and transfer to smart eyeglasses 102 through wireless communication system 103 or wired connections 104.

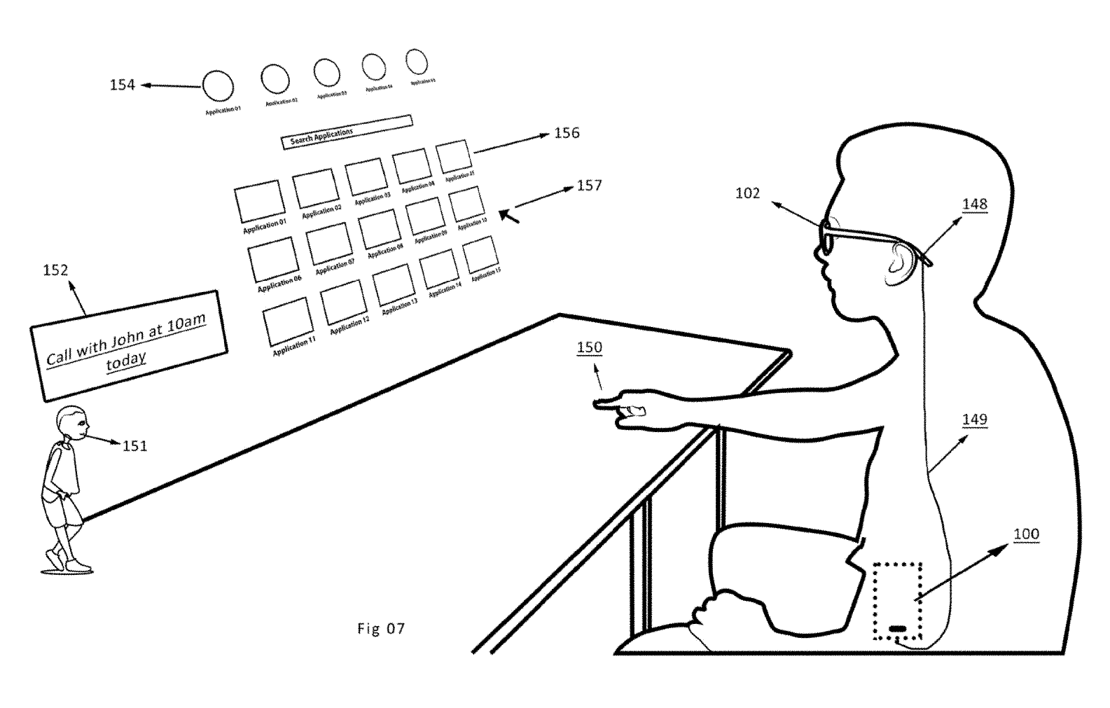

FIG. 7 illustrates an example of smart eyeglasses 102 that have displayed an application menu 156, according to some embodiments. The example smart eyeglasses 102 can have displayed an application menu and an intelligent avatar 151 that is augmented in the real-world environment of user's field of view. In this example user also uses a wired connection 149 with mobile computing device 100 and smart eyeglasses 102. User can choose between wired or wireless depending on user's interest. Some example cases like user may sit somewhere or not moving or walking, those scenarios user can easily plugin the magnetic cable connector 148 to smart eyeglasses 102 and another end can connect to the mobile computing device 100. When wired connections enabled then Wi-Fi may be disabled and also smart eyeglasses 102 can take battery power from mobile computing device 100 or other attached battery pack to provide long battery backup, long time usage and high performance. The mobile computing device 100 or smart eyeglasses 102 generated outputs 151, 152, 154, 156, 157 which appears in the real world of a user field of view and can be interacted with by using finger gestures 150 or touch surface on the mobile computing device 100 or other input methods. The artificial intelligent avatar 151 is highly customizable by user and it can deliver important notifications 152 and other information including but not limited to user's health data, health alerts, social media updates, application notifications from mobile computing device 100, information about objects recognized in front of users view area, locations and map, social connections and their updates, friends updates and nearby friends details, reminders and calendar notifications, details of people Who is in front of user's field of view, user's home data, vehicle data etc. and display these information blended in the user's real world environment of users field of view. User can interact with above mentioned data or information by using input methods including but not limited to hand or finger gestures, voice, touch, eye movements, mouse, keyboard, brain inputs, thought inputs, etc. Artificial intelligent avatar can act as a personal assistant for the user. Example, artificial intelligent avatar 151 can appear in the user's field of view and can display reminder notification 152 to the user.

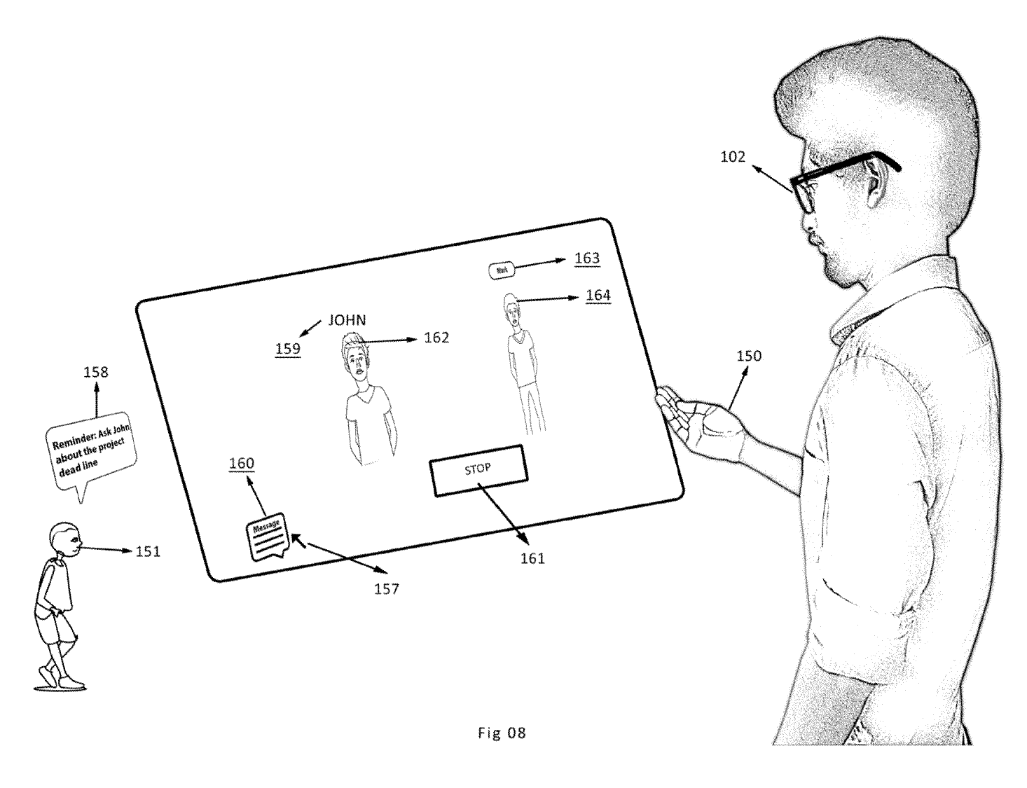

FIG. 8 illustrates an example wherein a user can navigate a cursor 157 through smart eyeglasses, according to some embodiments. The user can navigate a cursor 157 through smart eyeglasses 102 displayed virtual space or displayed outputs by moving thumb over other fingers and tap thumb on the other fingers 150 to select an item or using other input methods including but not limited to touchpad in the mobile computing device 100. The Depth/3D/20 video camera attached with smart eyeglasses 102 can process the real-time video frames or point cloud-based data to identify the gestures using processor, memory and application in the smart eyeglasses 102, or from mobile computing device. The artificial intelligent avatar 151 is highly customizable by user and it can deliver important notifications and other information including but not limited to user's health data, health alerts, social media updates, application notifications from mobile computing device 100, information about objects recognized in front of users view area, locations and map, social connections and their updates, friends updates and nearby friends details, reminders and calendar notifications, details of people who are in front of user's field of view, information or reply for any user's inputs by gestures, voice, touch, mood and automatically recognized user related details, connected home details and updates, vehicle details and updates, etc. to the user in a augmented reality form. artificial intelligent avatar can act as a personal assistant for the user. Example, artificial intelligent avatar 151 can appear in the user's field of view in the real world and can display reminder notification 158 to the user. This figure showing an example of video calling application. In this the video data may be fetched from application software installed in the mobile computing device and stream in real time to smart eyeglasses 102.

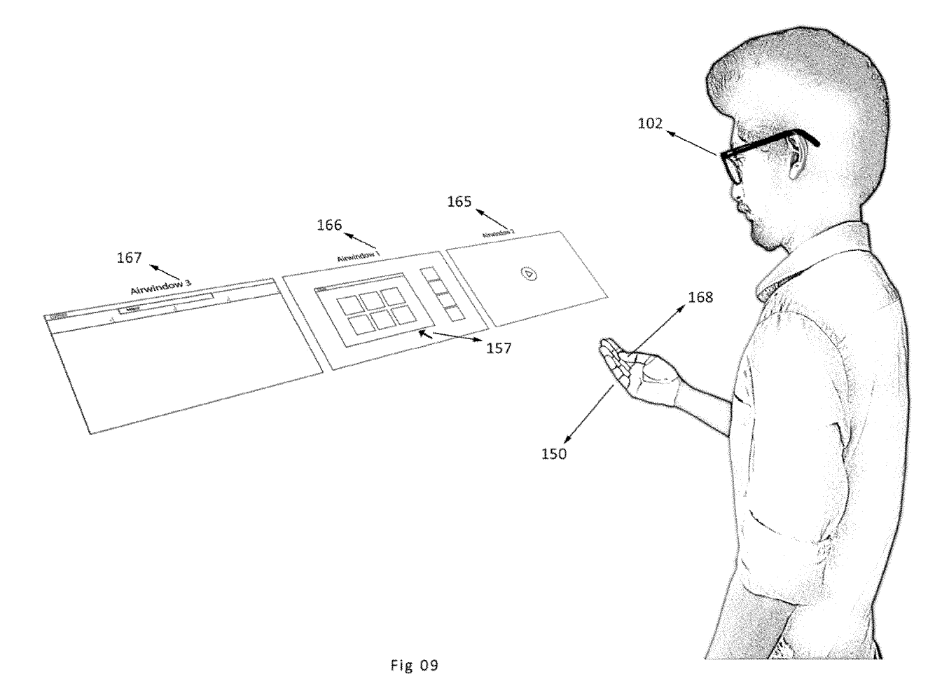

FIG. 9 illustrates an example system wherein a user can manage multiple instant application windows 165, 166, 167 using smart eyeglasses 102 and gesture input, according to some embodiments. A cursor 157 can move around the screen to select and navigate the application options. User can scroll up/down, scroll left/right by moving thumb 168 up/down/left/right over other fingers 150. Using the 3D/depth camera or 2D camera in the smart eyeglasses 102 can capture the real-time images of user's hand and fingers. Smart eyeglasses 102 can process the real-time video frames or point cloud-based data to identify the gestures using processor, memory and application in the smart eyeglasses 102, or from mobile computing device 100. User can also use other input methods including but not limited to hand or finger gestures, voice, touch, eye movements, mouse, keyboard, brain inputs, thought inputs, etc. to interact with the outputs displayed/generated in the smart eyeglasses 102.

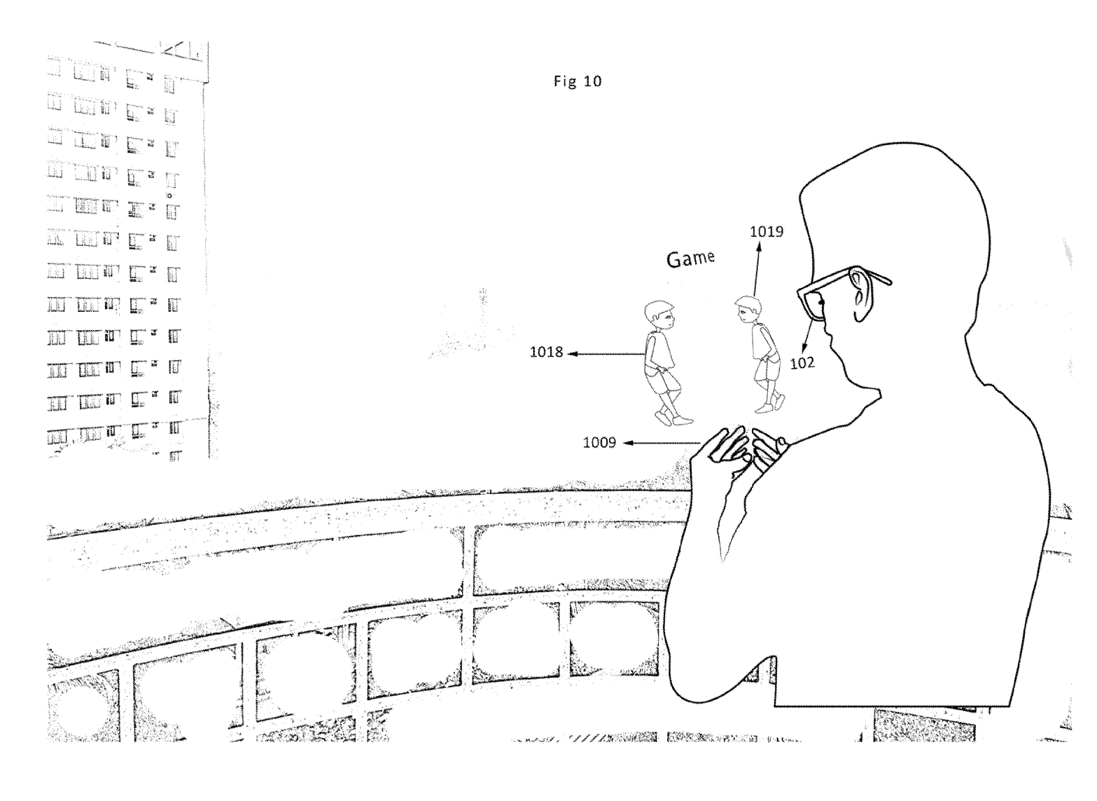

FIG. 10 an example use case with user playing games, according to some embodiments. The graphical processing can be implemented on the mobile computing device that then live streams the output into the smart eyeglasses 102. The user can move the thumb over other fingers 1009 to control the characters 1018 and 1019 in the game. The mobile computing device can recognize the user's thumb and finger 1009 movement and convert that into game controls. This can be reflected in the game and the output can transfer to smart eyeglasses 102 through wireless communication system using protocols including, inter alia: to Real-time Transport Protocol (RTP), Real Time Streaming Protocol (RTS) etc.

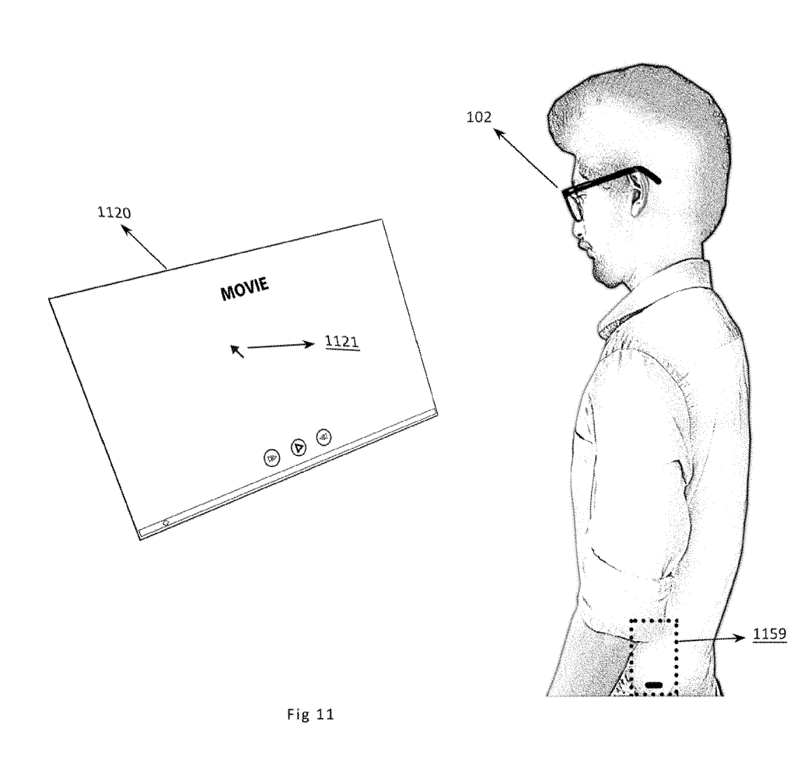

FIG. 11 illustrates an example of a user watching videos and/or images 1120 in a bigger screen size using smart eyeglasses 102, according to some embodiments. As shown, a user can navigate through the video window 1120 using thumb and/or finger movements. A cursor 1121 can move based on the user's movement of thumb over other fingers.

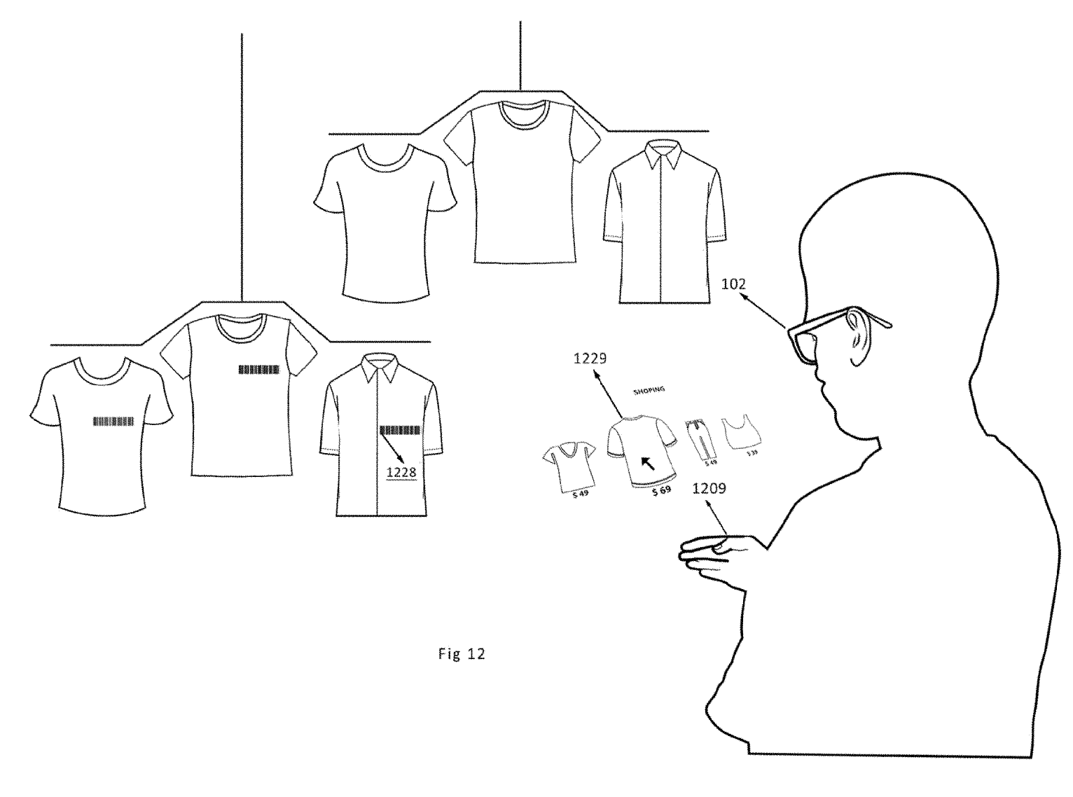

FIG. 12 illustrates an example of augmented reality shopping and suggestions, according to some embodiments. Input finger gestures 1209 can be used to navigate through the mobile computing system generated output 1229 displayed in the smart eyeglasses 102. The user can swipe thumb over other fingers 109 to change the displayed items and/or images and/or tap thumb on the other fingers to select items. A video camera attached in the smart eyeglasses 102 can stream the data into mobile computing device to identify the gestures. The video camera can be attached in the smart eyeglasses 102. The video camera can obtain information (e.g. as a digital feed, etc.) from the real-world in front of users view and live stream the video output into application installed in the mobile computing device through wireless communication system using protocols including inter alia: Real-time Transport Protocol (RTP), Real Time Streaming Protocol (RTS) etc., to identify objects, unique codes, QR codes, bar code and/or any other shapes. In one example, the video camera can be included (e.g. attached, etc.) in smart eyeglasses 102. The video camera can camera can live stream the video output into an applicable application installed in a local mobile computing device in order to identify the barcode 128 and fetch more details about the product including inter alia: price, offers, related products etc. It can generate that output in the application installed in the mobile computing device. These outputs can be transferred to smart eyeglasses 102 through wireless communication system.

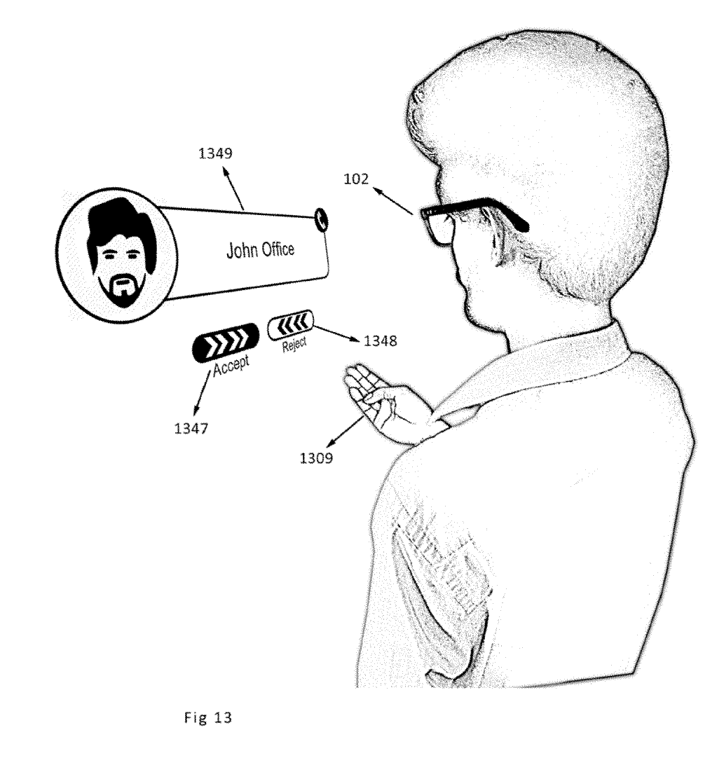

FIG. 13 illustrates an example of a user receiving calls, application notifications, reminders, alarms, social media updates etc. with the smart eyeglasses 102 via a local mobile computing device, according to some embodiments. As shown, the user can see the calling option with details 1349, including, inter alia: caller name, phone number, photo, accept 1347, reject 1348, mute, etc. The user can then select options through gestures or touch inputs. When the user receives a call, the call details can be displayed. The user can swipe right/left to accept/reject the call by moving thumb over the other fingers 1309.

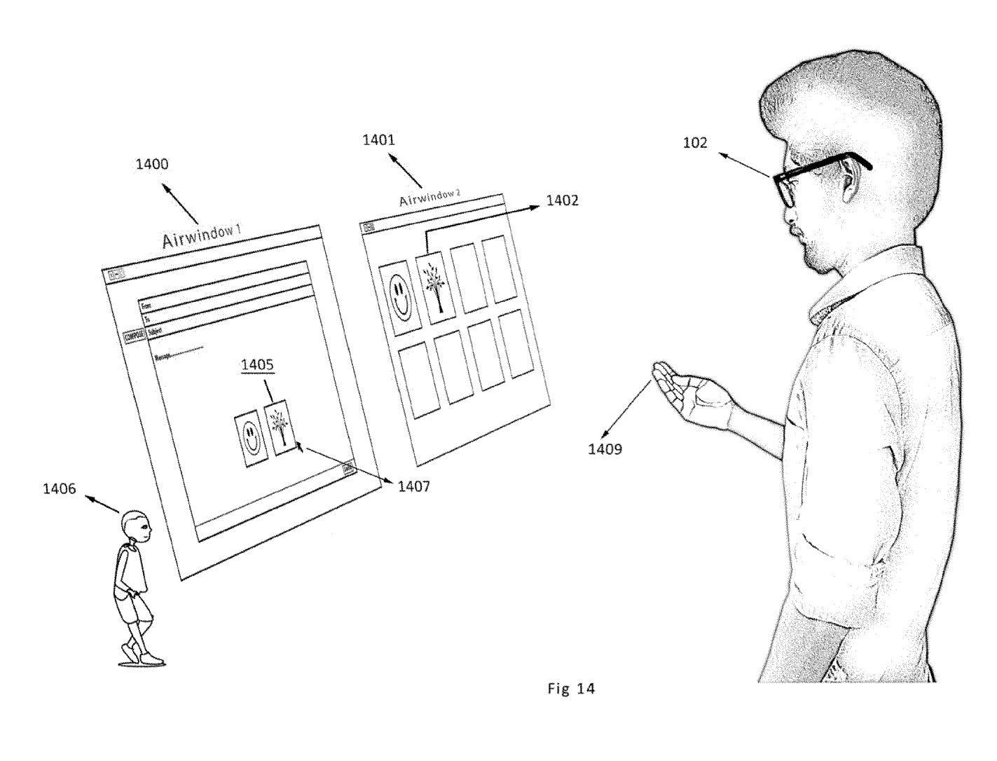

FIG. 14 illustrates an example of a user moving files between air windows 1400 and 1401 using cursor 1407 and hand gestures 1409, according to some embodiments. Artificial Intelligent Avatar 1406 can act as a personal assistant for the user. For example, Artificial Intelligent Avatar 1406 can appear in the user's field of view in the real world and can display reminder notification to the user. From the FIG. 1402 is a sample image from the image gallery. The image 1405 is dragged from air window 2 1401.

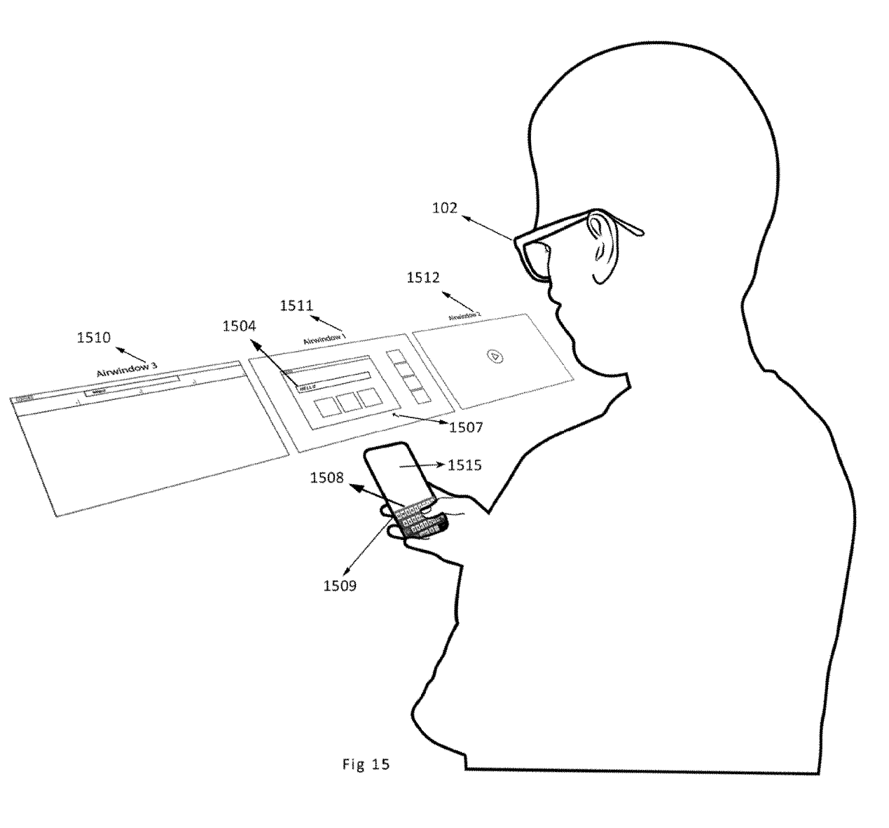

FIG. 15 illustrates an example of a user providing input to smart eyeglasses 102 using mobile computing device 1509 touch interfaces 1508 and 1515, according to some embodiments. Mobile computing device 109 can include a virtual keyboard 1508. A user can type text using a virtual keyboard 1508 in the mobile computing device 1509. The output can be reflected/displayed in smart eyeglasses 102. User can navigate a cursor 1507 through air windows 1510, 1511, 1512 by using touch surface/trackpad 1515 on the mobile computing device 1509,

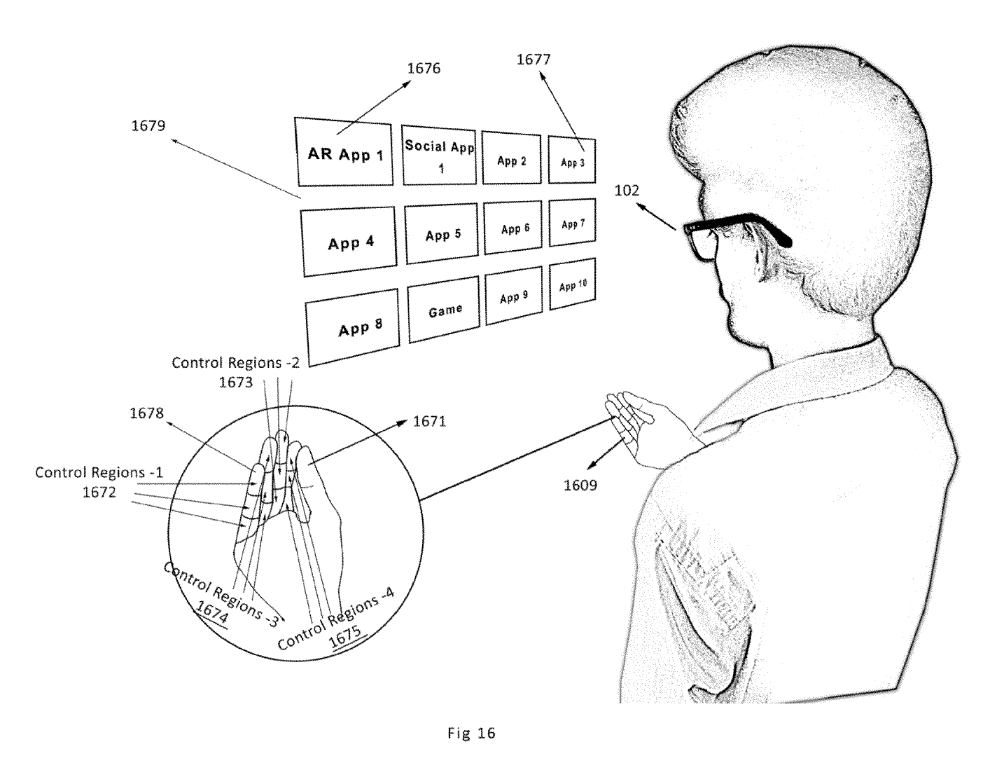

FIG. 16 illustrates a user using hand 1609 to provide input(s) to the smart eyeglasses 102, according to some embodiments. 3D/depth camera and/or 2D camera can be embedded in smart eyeglasses 1609. A local mobile device (and/or smart eyeglasses 1609) can include object-recognition functions used to identify user inputs from their fingers and thumb movements. For example, 3D/depth camera or 2D camera can capture user's hand 1609 images in real time (e.g. assuming networking and/or processing latencies, etc.) and communicate this information to mobile computing device to identify the inputs or gestures. As shown in FIG. 16, smart eyeglasses 1602 can display an application menu in augmented Form 1679. In this way, the user can see the real world and the virtual digital application menu 1679 placed in the real world. In order to select the applications and/or functions, the user can tap thumb 171 on any of the control region(s) 1672, 1673, 1674, 1675. 3D/depth camera or 2D camera can capture the hand images and then send to mobile computing device/smart eyeglasses can be able to identify thumb position, movement, location with respect to other fingers etc., this can help to identify which area of control region that user has tapped. Control region(s)—one (1) 1672, control region(s)—two (2) 1673, control region(s)—three (3) 1674, control region(s)—four (4) 1675 have three (3) control region(s) for each. According, a total of twelve (12) control region(s) are present in one hand. User can use both hands for configuring different applications and functions. Both hands can have twenty-four (24) control region(s) in total. For example, if the user wishes to open augmented-reality (AR) application one (1) 1676, the user can touch thumb 1671 on control region 1678. Using 3D/depth camera and/or 2D camera and/or application installed in the mobile computing device can identify an exact control region user tapped using thumb 1671 and then corresponding application AR application one (1) 1676 can access.

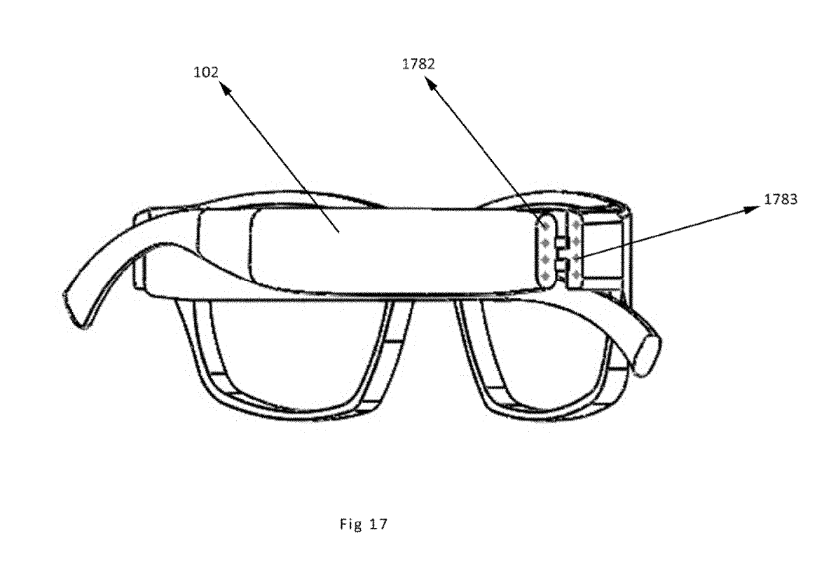

FIG. 17 illustrates an example wake up and sleep process of smart eyeglasses 103, according to some embodiments. When the user folds the temples of the smart eyeglasses, the magnetic connector 1782 can detach from the opposite connector 1783. When this detachment happens then the smart eyeglass will securely lock and go into sleep mode. This will allow securing the user data from others as well as to save power. When user open the temples the magnetic connectors 1783 and 1782 can come into contact with each other and the smart eyeglasses 103 can wake up and ask for security unlock. User can unlock the smart eyeglasses 103 by using methods including but not limited to fingerprint sensor embedded in the smart eyeglasses, pattern or numerical unlock from mobile computing device, fingerprint sensor embedded in a mobile computing device, retinal scanning sensors embedded in the smart eyeglasses 103, voice recognition etc.

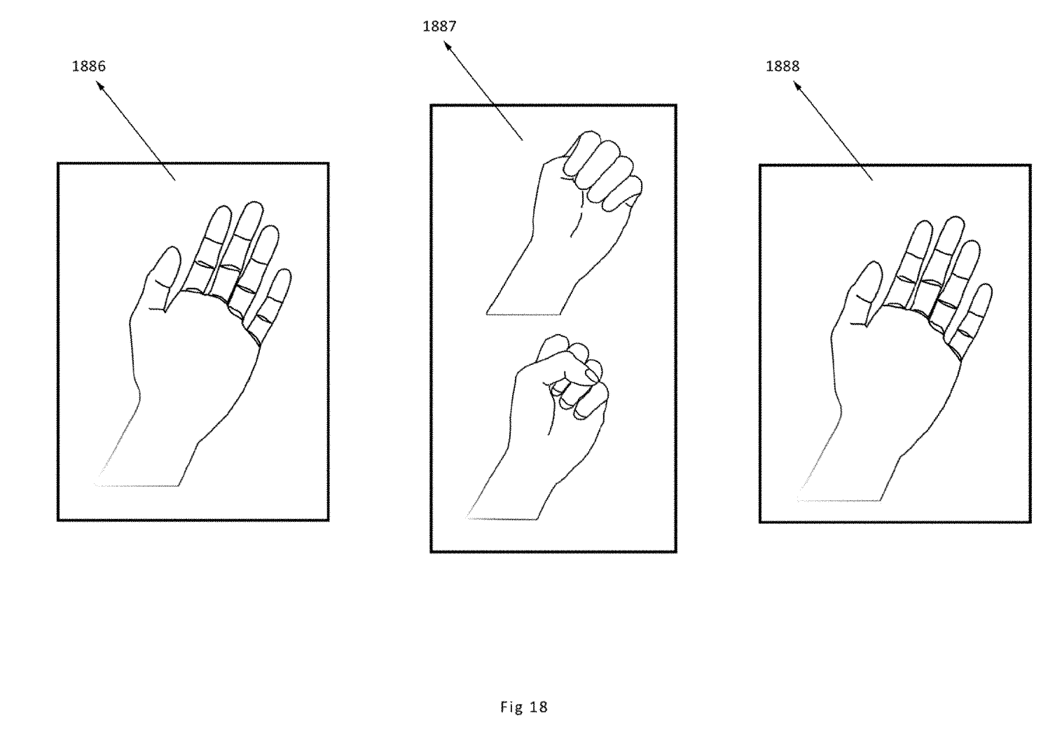

FIG. 18 illustrates a process of placing a user's hand 1886 in the field of view of 3D/Depth video camera or 2D Video camera, according to some embodiments. Accordingly, the user's hand 1886 can be identified. Once the user folds fist 1887 and open hand 1888 in a predefined time interval, the smart eyeglasses 102 and/or a mobile computing device can identify the gesture and perform the assigned functionality of the performed gesture and the output can be displayed in the smart eyeglasses 102.

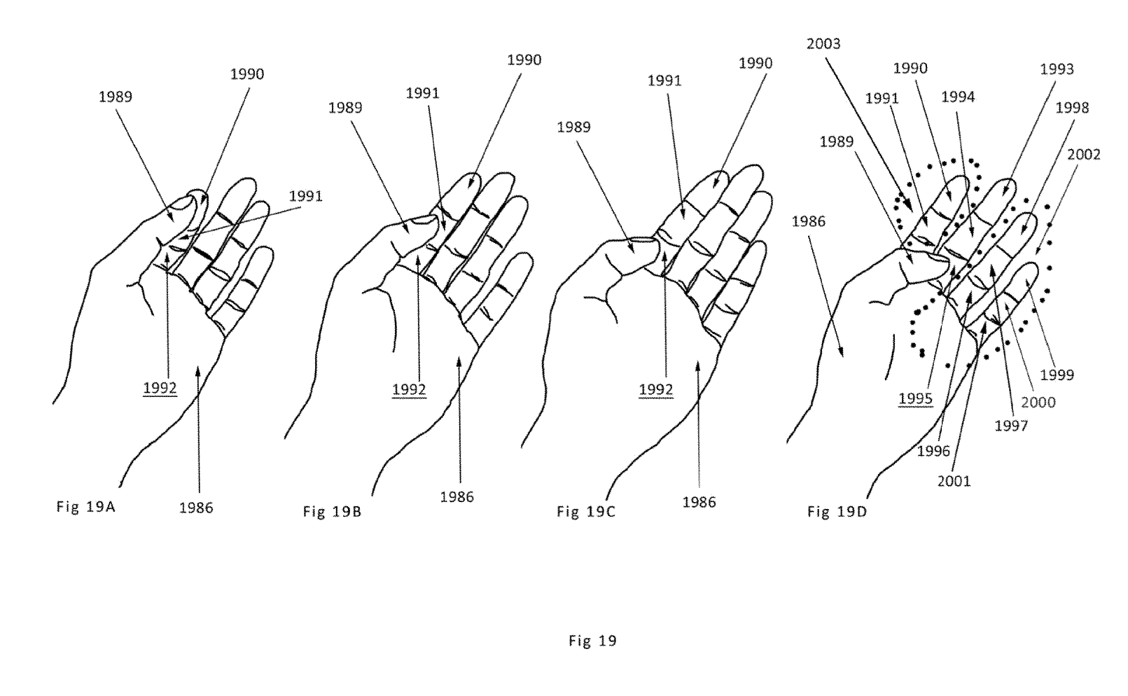

FIGS. 19 A-D illustrate a process of a user hand 1986 placed in the field of view of a video camera embedded in the smart eyeglasses, according to some embodiments. In this way, the position, depth and finger joints of all the fingers can be tracked and which finger segments of the four fingers, that the user is tapping with the thump 1989 can be identified (e.g. using input data from 3D/Depth video camera or 2D video camera 146 and/or computer vision, object recognition, etc.). There can be twelve (12) such distinct finger segments 1990, 1991, 1992, 1993, 1994, 1995, 1996, 1997 1998, 1999, 2000, 2001 in total on the four fingers of one hand 1986 which can be assigned to various different functionalities. This can be achieved separately on each of the hands. To define a user assigned thump 1089 tap gesture as in example FIG. 19A, when the thump 1089 is tapping on the finger segment 1090, the smart eyeglasses 102 embedded with a video camera can recognize the user hand 1986 and identify depth of fingers and thumb and exactly on which finger segment the thump 1989 is tapping. This can be implemented by the algorithm running in the smart eyeglasses 102 and/or the mobile computing device by recognizing the position of the thumb 1989 and identifying other fingers and finger segments which are not overlapped by the thumb 1989, with, respect to the position of the thumb 1989 towards its left or right directions or up or down direction.

It is noted that the distance between thumb and fingers can be identified. This can help to identify when the user thumb is touched on the other fingers or palm. Using the depth data from each part of the image from the depth camera the Z-axis of thumb and other fingers can be identified. The images from the depth camera will contain hand images. First we will filter hand only from the images. Once the digital image of the hand is obtained, segments for each fingers and thumb can be created. Once the digital image of the fingers and thumb is obtained, each part of each finger can be obtained. For example, each finger can be set to have three (3) parts separated without joints. So total if a process uses four (4) fingers of one hand, then there can be twelve (12) segments. Accordingly, using the digital images, the position of thumb and where the thumb is overlapped with other finger segments can be identified.

In FIG. 19D, there are two fingers 2002 which are not overlapped by the thumb towards the right direction of the thumb 1989 and there is one finger 2003 towards the left direction of the thumb 1989. This can enable the algorithm to recognize that the thumb 1989 is tapping on the middle finger 1995 of the user hand. Accordingly, the algorithm can identify precisely on which finger segment of the middle finger that the thumb 1989 is tapping by recognizing the two finger segments 1993, 1994 which are not overlapped by the thumb 1989 and there by the algorithm can realize that the thumb 1989 is tapping on the finger segment 9195 and the assigned function can be executed and output can be displayed on the smart glasses 102. Subsequently the same method is followed in examples of FIGS. 19A-C or example.

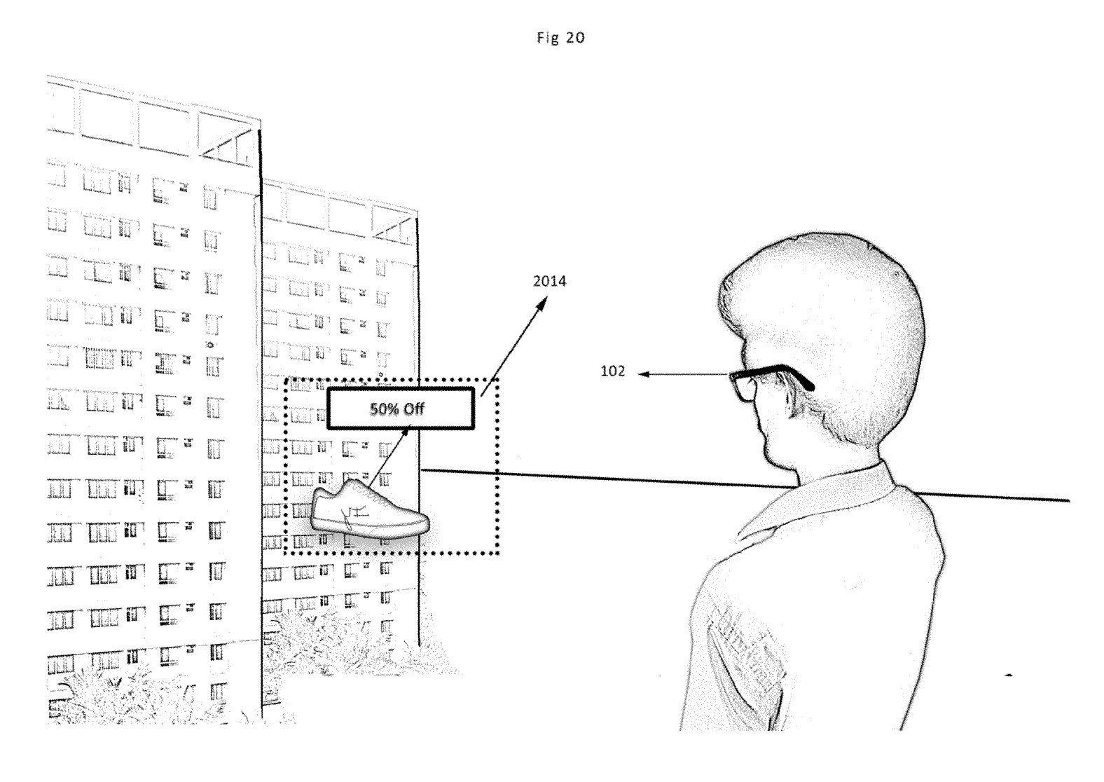

FIG. 20 illustrates a user adding their interest in buying items in the smart glasses 102, according to some embodiments. When a user visits a retail or other space with items for sale, a smart glasses system can recognize related items from buying user's list. These related items can ‘pop up’ in an AR manner on display 2004. Based on the user location and direction (e.g. using technologies including inter alia: GPS, Geo Location, magnetometer, Beacon, gyroscope etc.) the smart eyeglasses 102 or a mobile computing device can identify nearby shops related to the items. These shops can then be displayed 2004 on the smart eyeglasses 102 as well as additional information (e.g. directions, location, hours of operation, price of items, other user reviews of the shop, etc.).

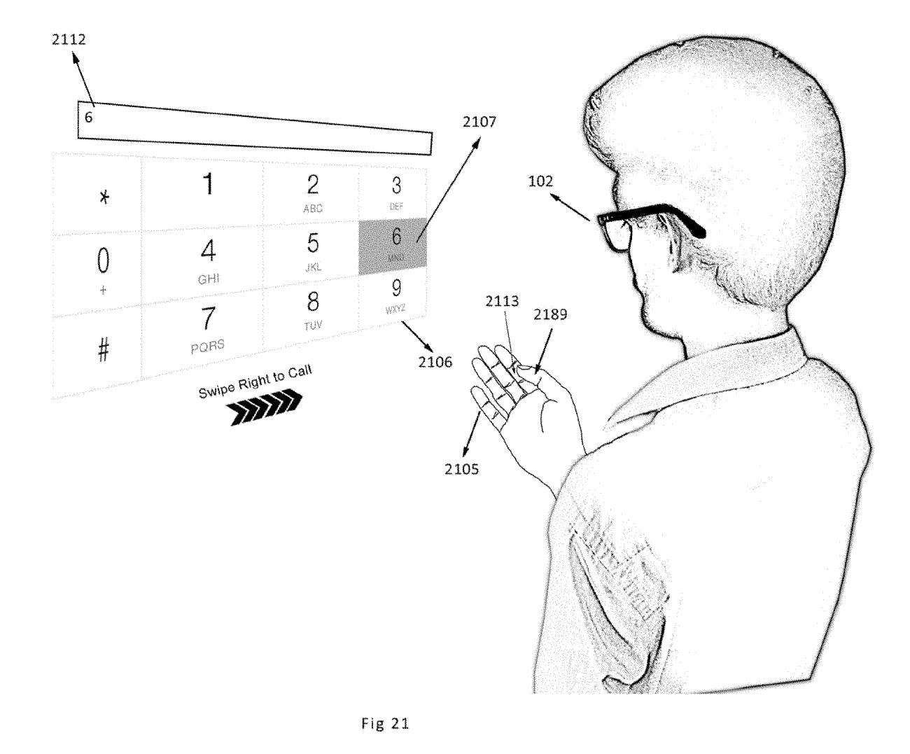

FIG. 21 illustrates a system used to identify user finger segments for dialing numbers or type alphabets, according to some embodiments. A user can use right hand 2105 and tap on any finger segment to dial a number or type alphabets. The thumb 2189 can tap on the finger segment 2113 to dial number six (6). The smart eyeglasses 102 can display the graphical image of number pad 2106 for user to see while tapping on each finger segments. When user the thumb 2189 taps on any of the finger segments of the hand 2105 the assigned function can be activated and displayed on the smart eyeglasses 102. In this example user tapped on the segment 213 and immediately the assigned function is activated 2107 in the smart eyeglasses 102 and that reflected on the graphical UI 2106 displayed on the smart glasses 102. In this way, a user can dial an example phone number and swipe right to make a call.

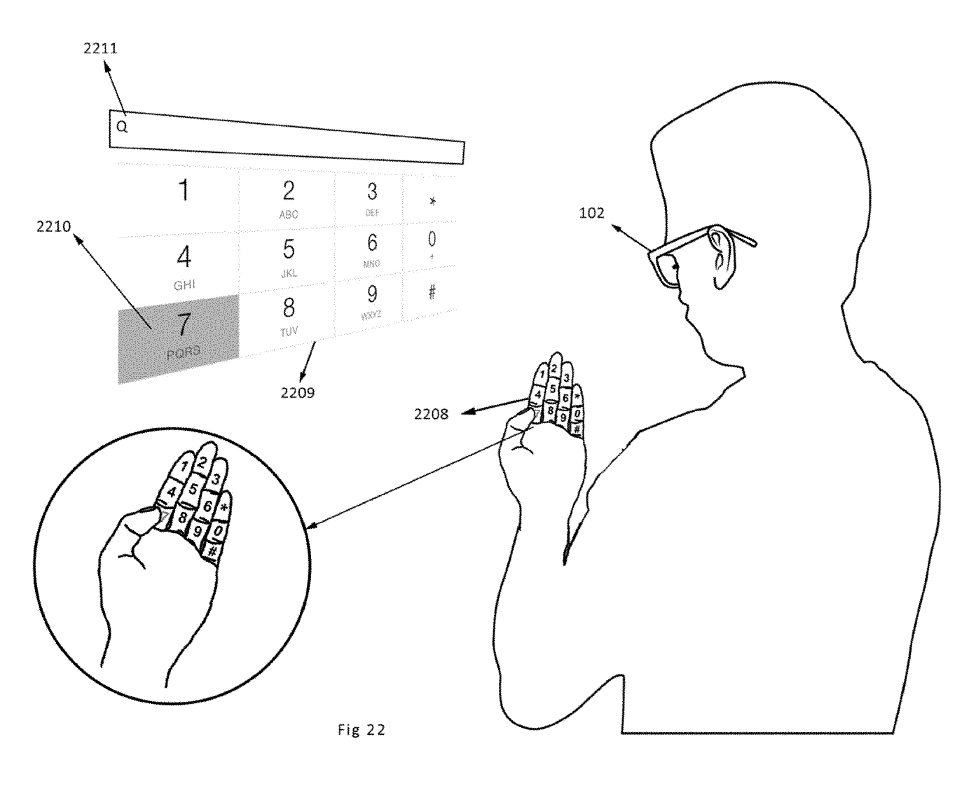

FIG. 22 illustrates a figure digital dial pad displayed on user finger segments 2208, according to some embodiments. The user can tap a finger segment. The tapped finger segment can be reflected or displayed in real time (e.g. assuming networking and/or processing latencies, etc.) in graphical UI 2209 and graphical UI 2211 on smart eyeglasses 102. The user can tap multiple times on the same segment to select alphabetic characters. For example, a user can tap three (3) times on the same segment to select alphabet ‘Q’. Selected alphabet characters can be displayed on the smart eyeglasses display 2211.

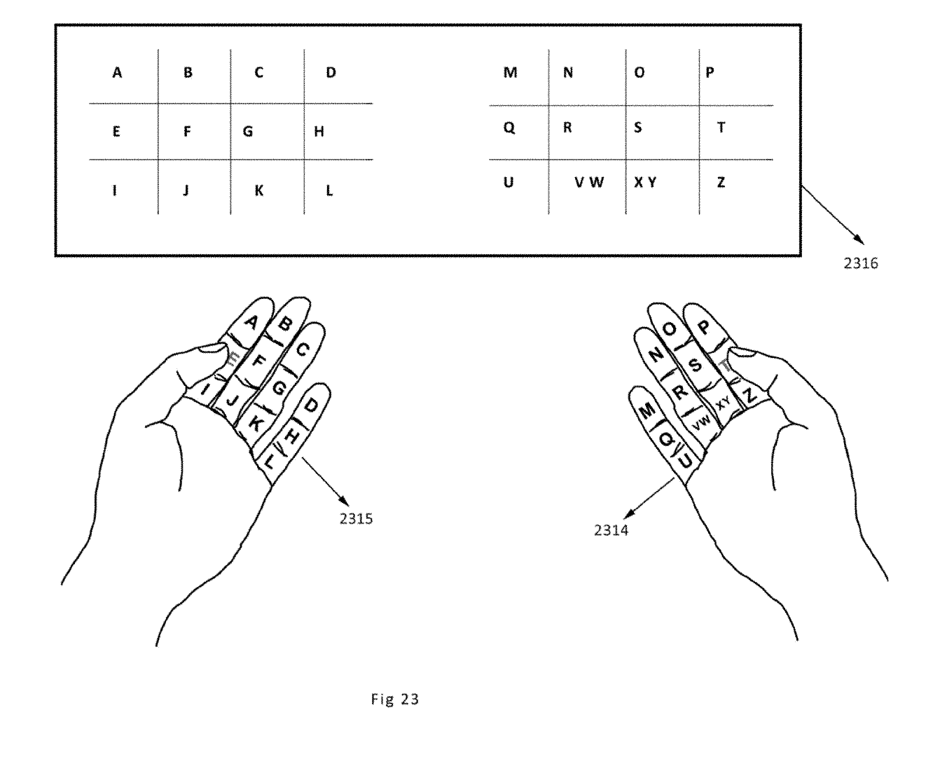

FIG. 23 illustrates an example alphabetic keyboard on two hands 2314 and 2315, according to some embodiments. The user can select each alphabetic character using thumb taping on the finger segments. The reference graphical keyboard 2316 can also displayed through smart glasses 102. Each finger segment can be recognized per the method provided supra, or comparable manner.

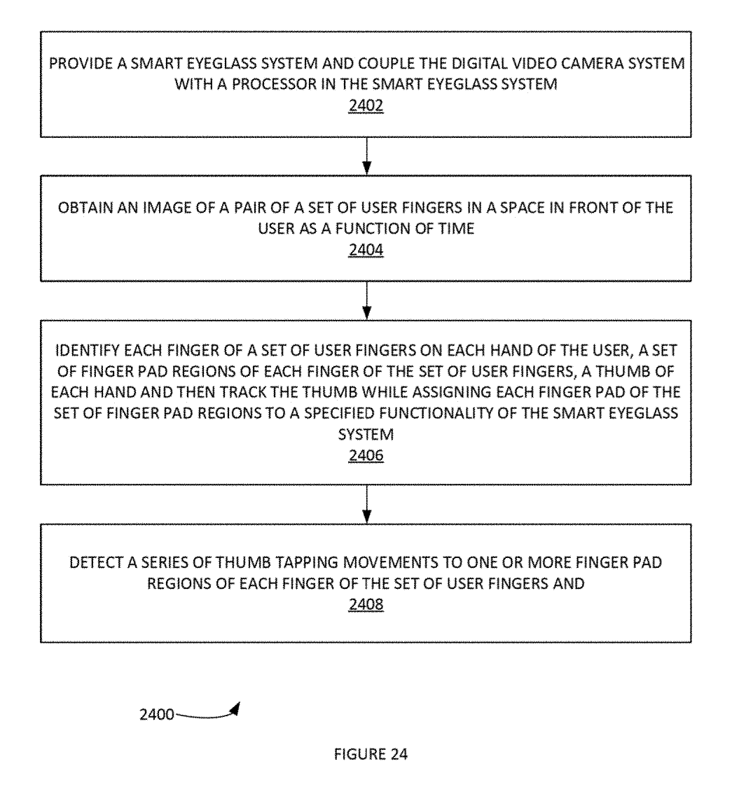

FIG. 24 illustrates an example process 2400 for implementing a smart eyeglass system, according to some embodiments. In step 2402, process 2400 provides a smart eyeglass system. The smart eyeglass system includes a digital video camera system. In step 2402, process 2400 couples the digital video camera system with a processor in the smart eyeglass system. The smart eyeglass system is worn by a user. With the video camera integrated into the smart eyeglass system process 2400, in step 2404, obtains an image of a pair of a set of user fingers in a space in front of the user as a function of time. A user's palm of each hand can face the video camera system. With the processor, in step 2406, process 2400 identifies each finger of a set of user fingers on each hand of the user. The method identifies a set of finger pad regions of each finger of the set of user fingers. The method identifies a thumb of each hand. The method tracks the thumb. The method assigns each finger pad of the set of finger pad regions to a specified functionality of the smart eyeglass system. In step 2408, process 2400 detects a series of thumb tapping movements to one or more finger pad regions of each finger of the set of user fingers. A tapping of a finger pad region is determined by the steps of identifying a set of other fingers and other finger pad regions that are not overlapped by the thumb and identifying which of the set of other fingers and the other finger pad regions that are left of the thumb, right of the thumb, above the thumb and below the thumb.

Additional Computing Systems

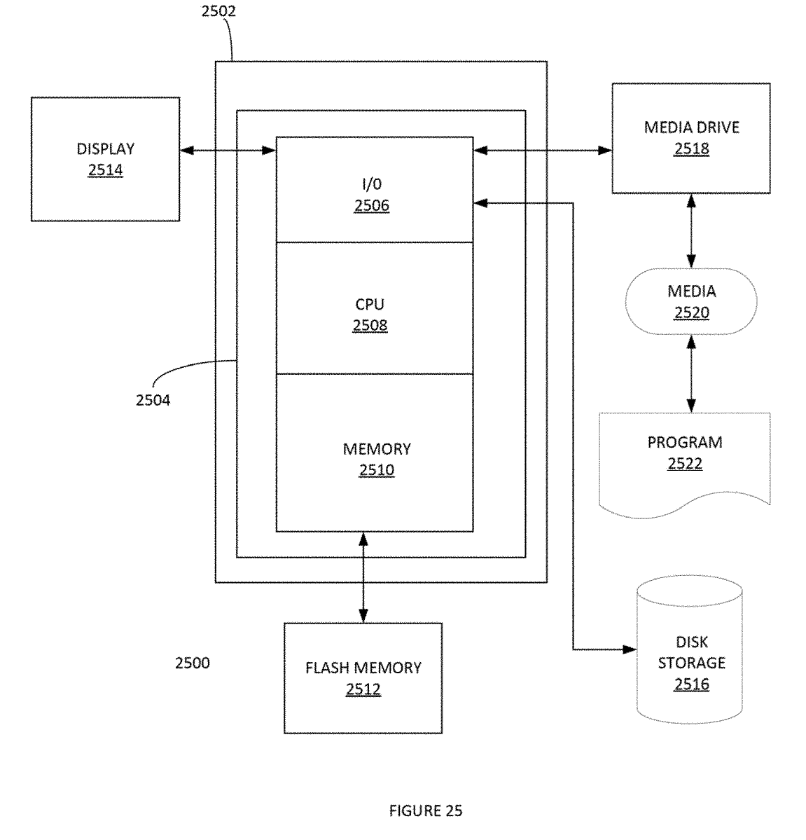

FIG. 25 depicts an exemplary computing system 2500 that can be configured to perform any one of the processes provided herein. In this context, computing system 2500 may include, for example, a processor, memory, storage, and I/O devices (e.g. monitor, keyboard, disk drive, Internet connection, etc.). However, computing system 2500 may include circuitry or other specialized hardware for carrying out some or all aspects of the processes. In some operational settings, computing system 2500 may be configured as a system that includes one or more units, each of which is configured to carry out some aspects of the processes either in software, hardware, or some combination thereof.

FIG. 25 depicts computing system 2500 with a number of components that may be used to perform any of the processes described herein. The main system 2502 includes a motherboard 2504 having an I/O section 2506, one or more central processing units (CPU) 2508, and a memory section 2510, which may have a flash memory card 2512 related to it. The I/O section 2506 can be connected to a display 2514, a keyboard and/or other user input (not shown), a disk storage unit 2516, and a media drive unit 2518. The media drive unit 2518 can read/write a computer-readable medium 2520, which can contain programs 2522 and/or data. Computing system 2500 can include a web browser. Moreover, it is noted that computing system 2500 can be configured to include additional systems in order to fulfill various functionalities. Computing system 2500 can communicate with other computing devices based on various computer communication protocols such a Wi-Fi, BLUETOOTH™ (and/or other standards for exchanging data over short distances includes those using short-wavelength radio transmissions), USB, Ethernet, cellular, an ultrasonic local area communication protocol, etc.

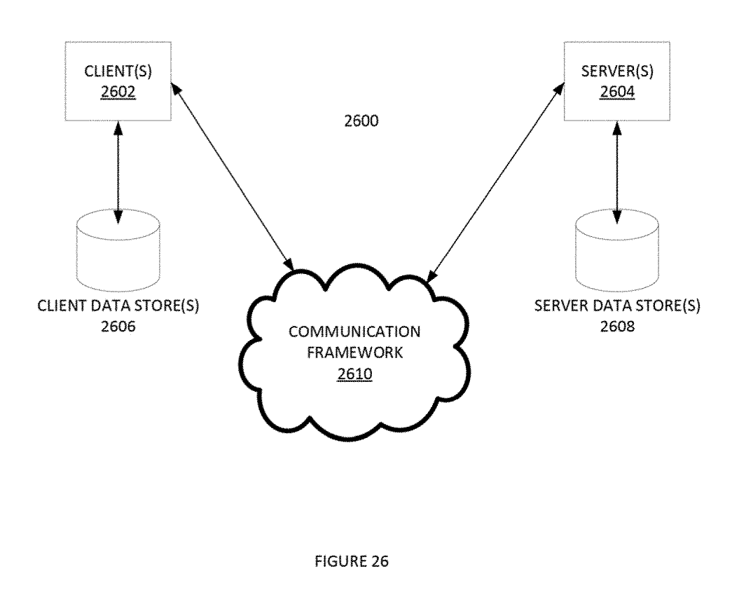

FIG. 26 is a block diagram of a sample computing environment 2600 that can be utilized to implement various embodiments. The system 2600 further illustrates a system that includes one or more client(s) 2602. The client(s) 2602 can be hardware and/or software (e.g. threads, processes, computing devices). The system 2600 also includes one or more server(s) 2604. The server(s) 2604 can also be hardware and/or software (e.g. threads, processes, computing devices). One possible communication between a client 2602 and a server 2604 may be in the form of;a data packet adapted to be transmitted between two or more computer processes. The system 2600 includes a communication framework 2610 that can be employed to facilitate communications between the client(s) 2602 and the server(s) 2604. The client(s) 2602 are connected to one or more client data store(s) 2606 that can be employed to store information local to the client(s) 2602. Similarly, the server(s) 2604 are connected to one or more server data store(s) 2608 that can be employed to store information local o the server(s) 2604. In some embodiments, system 2600 can instead be a collection of remote computing services constituting a cloud-computing platform.

Additional Method

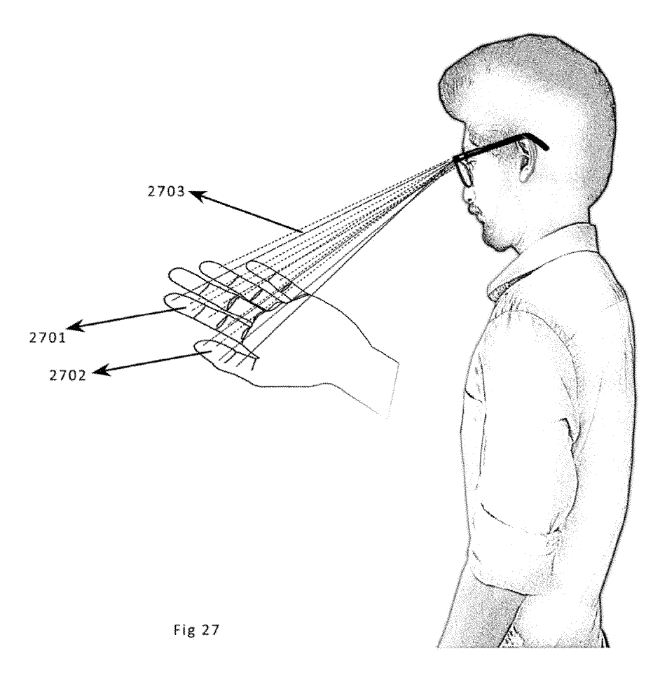

FIG. 27 an example depth camera process, according to some embodiments. The depth camera attached in the wearable smart glass can transmit the infrared (IR) rays 2703 to the user's hand. The rays then touch on the different areas of the palm. The reflected rays can recognize by the IR camera attached in the wearable smart glasses. Using this data, the processor can identify the position, angle and depth difference of each the fingers and thumb. When thumb touch on the other fingers then the depth different between the thumb and other fingers will be less compared to the thumb not touched on the other fingers. When the thumb touches anywhere on the palm then the algorithm will detect that and start checking the position and angle of fingers and thumb. This can enable the recognition of which segment of the palms user touched using the thumb.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system), and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of a smart eyeglass system comprising:
providing a smart eyeglass system, wherein the smart eyeglass system comprises a digital video camera system, wherein the digital video camera system is coupled with a processor in the smart eyeglass system, and wherein the smart eyeglass system is worn by a user;
with the video camera integrated into the smart eyeglass system:
obtaining an image of a pair of a set of user fingers in a space in front of the user as a function of time, wherein a user's palm of each hand is facing the video camera system;
with the processor:
identifying each finger of a set of user fingers on each hand of the user;
identifying a set of finger pad regions of each finger of the set of user fingers;
identifying a thumb of each hand; and
tracking the thumb;
assigning each finger pad of the set of finger pad regions to a specified functionality of the smart eyeglass system; and
detecting a series of thumb tapping movements to one or more finger pad regions of each finger of the set of user fingers.

2. The method of claim 1, wherein a tapping of a finger pad region is determined by:
identifying a set of other fingers and other finger pad regions that are not overlapped by the thumb.

3. The method of claim 2, wherein a tapping of a finger pad region is further determined by:
identifying which of the set of other fingers and the other finger pad regions that are left of the thumb, right of the thumb, above the thumb and below the thumb.

4. A smart eyeglass system comprising:
a smart eyeglass system, wherein the smart eyeglass system comprises a digital video camera system, wherein the digital video camera system is coupled with a processor in the smart eyeglass system, and wherein the smart eyeglass system is worn by a user;
wherein the video camera integrated into the smart eyeglass system is configured to obtain an image of a pair of a set of user fingers in a space in front of the user as a function of time, wherein a user's palm of each hand is facing the video camera system;
with the processor smart eyeglass system:
identify each finger of a set of user fingers on each hand of the user;
identify a set of finger pad regions of each finger of the set of user fingers;
identify thumb of each hand;
track the thumb;
assign each finger pad of the set of finger pad regions to a specified functionality of the smart eyeglass system; and
detect a series of thumb tapping movements to one or more finger pad regions of each finger of the set of user fingers;
identify a set of other fingers and other finger pad regions that are not overlapped by the thumb; and
identify which of the set of other fingers and the other finger pad regions that are left of the thumb, right of the thumb, above the thumb and below the thumb.
